(19) United States
(12) Patent Application Publication
(10) Pub. No.: US 2026/0045701 A1
(43) Pub. Date: Feb. 12, 2026

(54) INTELLIGENT REFLECTING SURFACE

(71) Applicant: Japan Display Inc., Tokyo (JP)

(72) Inventors: Kazuki MATSUNAGA, Tokyo (JP); Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 19/363,718

(22) Filed: Oct. 21, 2025

Related U.S. Application Data
(63) Continuation of application No. PCT/JP2024/011803, filed on Mar. 26, 2024.

(30) Foreign Application Priority Data
May 15, 2023 (JP) 2023-080200

(51) Int. Cl. H01Q 15/14; H01Q 1/52

(52) U.S. Cl. CPC H01Q 15/148; H01Q 1/52

(57) ABSTRACT

An intelligent reflecting surface comprises a first substrate, a second substrate located opposite to the first substrate and a seal portion arranged between the first substrate and the second substrate. A plurality of first electrodes is arranged on the first substrate. A plurality of second electrodes is arranged on the second substrate. A liquid crystal layer is arranged between the first substrate and the second substrate. Each of the second electrodes faces each of the first electrodes. The seal portion encloses the liquid crystal layer between the first substrate and the second substrate. The seal portion contains a material suppressing reflection of radio waves.

### CROSS-REFERENCE TO RELATED APPLICATIONS

This application is a Continuation of International Patent Application No. PCT/JP2024/011803, filed on Mar. 26, 2024, which claims the benefit of priority to Japanese Patent Application No. 2023-080200 filed on May 15, 2023, the entire contents of each are incorporated herein by reference.

### FIELD

An embodiment of the present invention relates to an intelligent reflecting surface.

### BACKGROUND

Conventionally, an intelligent reflecting surface is known that changes the dielectric constant of a liquid crystal element for each area where radio waves are incident, changes the phase of radio waves passing through liquid crystal elements having different dielectric constants, and controls amplitudes, directions, and the like of reflected radio waves (for example, Japanese laid-open patent publication No. 2022-156917).

### SUMMARY

An intelligent reflecting surface according to an embodiment of the present invention includes: a first substrate including a plurality of first electrodes arranged on the first substrate; a second substrate including a plurality of second electrodes arranged on the second substrate opposite to the first substrate, a liquid crystal layer is arranged between the first substrate and second substrate, and each of the second electrodes faces each of the first electrodes; and a seal portion, arranged between the first substrate and the second substrate, enclosing the liquid crystal layer between the first substrate and the second substrate, wherein the seal portion contains a material suppressing reflection of radio waves.

### BRIEF DESCRIPTION OF DRAWINGS

FIG. 1 is a perspective view for explaining an overview of an intelligent reflecting surface according to an embodiment of the present invention.

FIG. 2 is a cross-sectional view of the intelligent reflecting surface shown in FIG. 1.

FIG. 3 is another cross-sectional view of the intelligent reflecting surface shown in FIG. 1.

FIG. 4 is another cross-sectional view of the intelligent reflecting surface shown in FIG. 1.

FIG. 5 is another cross-sectional view of the intelligent reflecting surface shown in FIG. 1.

FIG. 6 is another cross-sectional view of the intelligent reflecting surface shown in FIG. 1.

FIG. 7 is a cross-sectional view of an intelligent reflecting surface according to a comparative example.

FIG. 8 is another cross-sectional view of the intelligent reflecting surface shown in FIG. 1.

FIG. 9 is an arrow view of the intelligent reflecting surface according to another embodiment of the present invention.

FIG. 10 is a schematic diagram of an intelligent reflecting surface according to another embodiment of the present invention.

FIG. 11 is a cross-sectional view of an intelligent reflecting surface according to a modification of the present invention.

### DESCRIPTION OF EMBODIMENTS

A wiring is arranged around a conventional intelligent reflecting surface to generate a potential difference between electrodes of a liquid crystal element and change the dielectric constant of the liquid crystal element.

In the conventional intelligent reflecting surface, it is preferable to reduce an amplitude of a radio wave reflected in a peripheral region in order to reflect a radio wave having an intended amplitude, direction, and the like as a whole.

An object of an embodiment of the present invention is to provide an intelligent reflecting surface that is less likely to generate unintended reflected waves.

Hereinafter, embodiments of the present invention will be described with reference to the drawings and the like. However, the present invention can be implemented in various aspects without departing from the gist thereof, and is not to be construed as being limited to the description of the embodiments exemplified below. In order to make the description clearer with respect to the drawings, the width, thickness, shape, and the like of each part may be schematically represented in comparison with actual embodiments, but the schematic drawings are merely examples, and do not limit the interpretation of the present invention. In the present specification and the drawings, elements that are the same as or similar to those described with respect to the above-described drawings are denoted by the same reference signs, and redundant description thereof may be omitted. In the present specification and the like, ordinal numbers are given for convenience in order to distinguish components, parts, and the like, and do not indicate priority or order.

In the present invention, in the case where a plurality of films is formed by processing a certain film, the plurality of films may have different functions and roles. However, the plurality of films is derived from a film formed as the same layer in the same process, and has the same layer structure and the same material. Therefore, the plurality of films is defined as being present in the same layer. Further, in the case where a plurality of films is formed by processing a certain film, in the present specification and the like, the films may be described separately using −1, −2, and the like.

In the present specification and the like, expressions such as “on” and “under” represent a relative positional relationship between a structure of interest and another structure. In the present specification and the like, in a side view, a direction from a second substrate to a first substrate to be described later is defined as “on”, and the opposite direction is defined as “under”. In the present specification and claims, when describing an embodiment of arranging a structure on a certain structure and simply expressing “above”, it includes both arranging a structure directly above a certain structure and arranging a structure above a certain structure via yet another structure, unless otherwise specified.

### First Embodiment

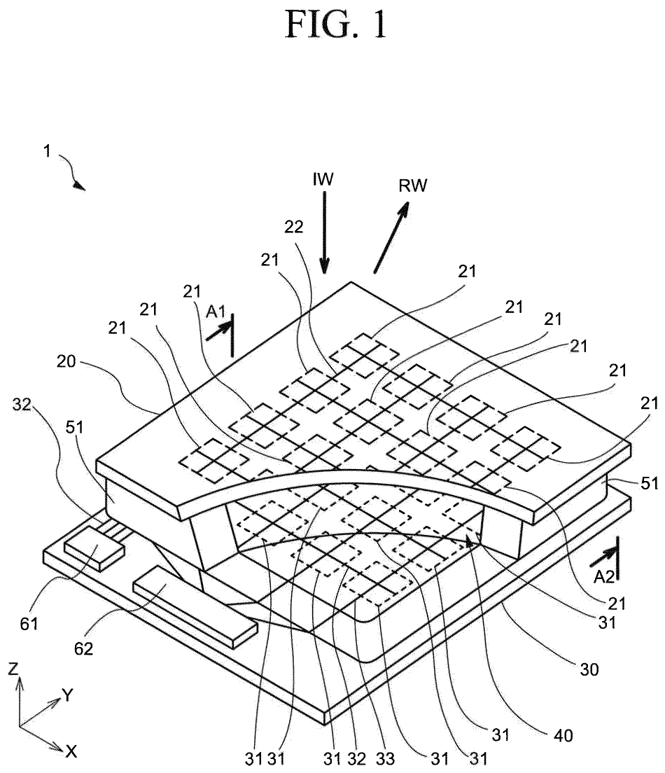

As shown in FIG. 1, an intelligent reflecting surface 1 according to an embodiment of the present invention includes a first substrate 20, a second substrate 30, and a liquid crystal layer 40. The intelligent reflecting surface 1 is a device that changes the dielectric constant of the liquid crystal layer 40, changes the phase of the radio wave incident from the first substrate 20 side, that is, the phase of an incident wave IW, reflects the radio wave in a predetermined direction, and emits a reflected wave RW. In addition, a radio wave reflection plate is also referred to as an IRS (Intelligent Reflecting Surface).

To facilitate understanding of the internal structure, the perspective view shown in FIG. 1 is a cut-away view of a portion of the first substrate 20, the liquid crystal layer 40, and a sealing material 51 surrounding the liquid crystal layer 40 from the intelligent reflecting surface 1. A plurality of patch electrodes 21 is arranged in the first substrate 20, and a plurality of ground electrodes 31 is arranged in the second substrate 30. The liquid crystal layer 40 and the sealing material 51 are provided between the first substrate 20 and the second substrate 30. The sealing material 51 is in contact with both the first substrate 20 and the second substrate 30 and surrounds the liquid crystal layer 40.

Although details will be described later, a common wiring 22 is connected to the patch electrode 21, and a bias signal line 32 and a selection signal line 33 are connected to the ground electrode 31. A connector 61 is a connection part that pulls out the bias signal line 32 from the intelligent reflecting surface 1. For example, a circuit element 62 includes an integrated circuit (IC), a capacitor, an electric resistor, a coil, and the like, and includes a circuit that supplies a bias signal to the selection signal line 33.

A direction X shown in FIG. 1 is a direction parallel to one side of the first substrate 20. A direction Y is a direction perpendicular to the direction X, and is a direction in which an XY plane is a plane parallel to the first substrate 20. A direction Z is a direction perpendicular to the XY plane and is a direction from the second substrate 30 toward the first substrate 20.

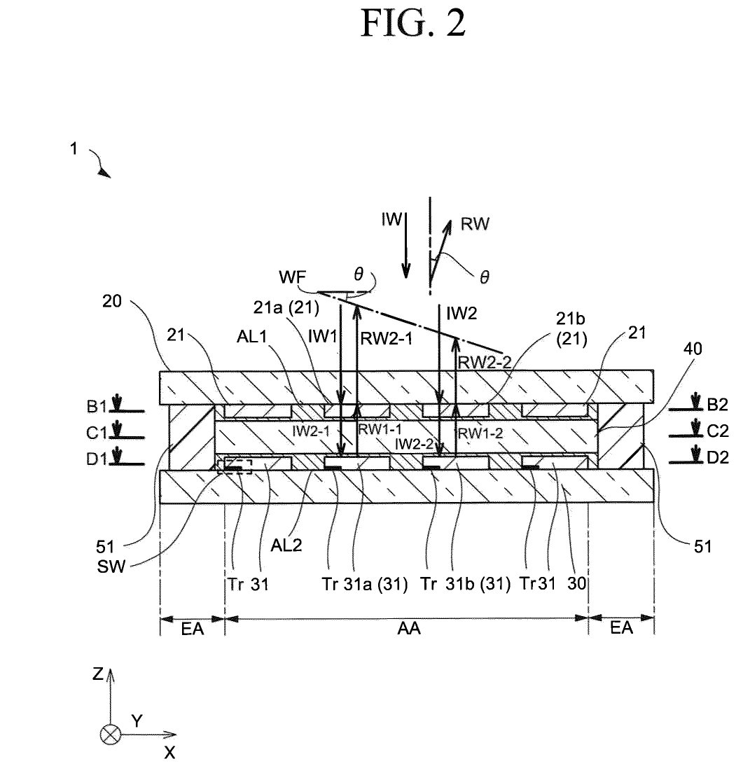

FIG. 2 is a cross-sectional view of the line A1-A2 of the intelligent reflecting surface 1 shown in FIG. 1. The plurality of patch electrodes 21 is arranged along the direction X on a surface of the two surfaces of the first substrate 20 that is in contact with the liquid crystal layer 40. The plurality of ground electrodes 31 is arranged on a surface of the two surfaces of the second substrate 30 that is in contact with the liquid crystal layer 40. The patch electrode 21 and the ground electrode 31 face each other in a one-to-one manner with the liquid crystal layer 40 sandwiched therebetween. That is, the respective patch electrodes 21 provided in the first substrate 20 have corresponding ground electrodes 31 on the second substrate 30.

An alignment film AL1 is provided in the first substrate 20, and the alignment film AL1 covers the plurality of patch electrodes 21. An alignment film AL2 is provided in the second substrate 30, and the alignment film AL2 covers the plurality of ground electrodes 31. For example, the alignment films AL1 and AL2 are horizontal alignment films, but are not limited to this. The alignment films AL1 and AL2 are in contact with the liquid crystal layer 40 and control the alignment of liquid crystal molecules contained in the liquid crystal layer 40. Hereinafter, the alignment films AL1 and AL2 will not be shown or described for ease of understanding.

The sealing material 51 including a material for suppressing the reflection of radio waves, which will be described later, surrounds the liquid crystal layer 40 from the outside and seals the liquid crystal of the liquid crystal layer 40 between the first substrate 20 and the second substrate 30. A region where the patch electrode 21 and the ground electrode 31 are arranged is an active region AA that is capable of actively controlling the dielectric constant of the liquid crystal layer 40. A region protruding from the active region AA in the direction X or the direction Y, for example, a region where the sealing material 51 is arranged, is a peripheral region EA that cannot actively control the dielectric constant of the liquid crystal layer 40. In FIG. 2, with respect to the direction X, the peripheral region EA is spread in the directions +X and −X respectively with the active region AA at the center. In addition, the active region AA in which the patch electrode 21 and the ground electrode 31 are arranged is spread in the directions +Y and −Y, and the peripheral region EA is present in the periphery thereof.

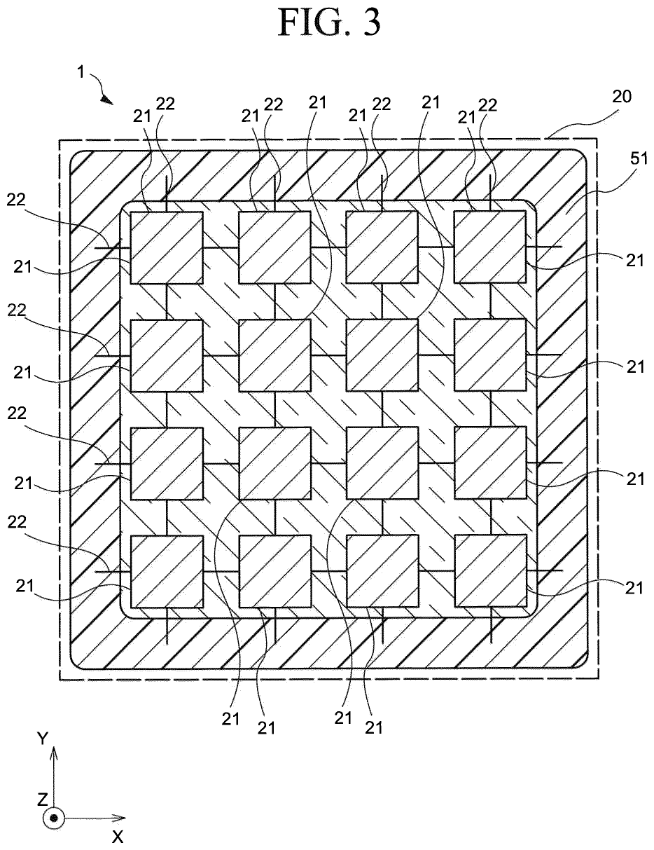

FIG. 3 shows a cross-sectional view of the line B1-B2 (see FIG. 2) of the intelligent reflecting surface 1. Sixteen patch electrodes 21 are arranged in the direction X and the direction Y to form a group, and are arranged in a lattice pattern of four rows and four columns. Each patch electrode 21 is formed in a square shape. For example, the length of one side of the square is 35 mm when the frequency of the incident wave IW (see FIG. 1) is 2.4 GHZ, 16.8 mm when 5.0 GHZ, and 3.0 mm when 28 GHz. All the patch electrodes 21 are electrically connected to each other by the common wiring 22, which is a conductive thin wire. The patch electrode 21 and the common wiring 22 are formed of a metal or a conductor corresponding to a metal. The patch electrode 21 and the common wiring 22 may be integrally formed as a transparent conductive layer containing, for example, a mixture of indium oxide and tin oxide (ITO). In addition, the shape of the patch electrode 21 is not limited to a square, and may be a rectangle or another geometric shape.

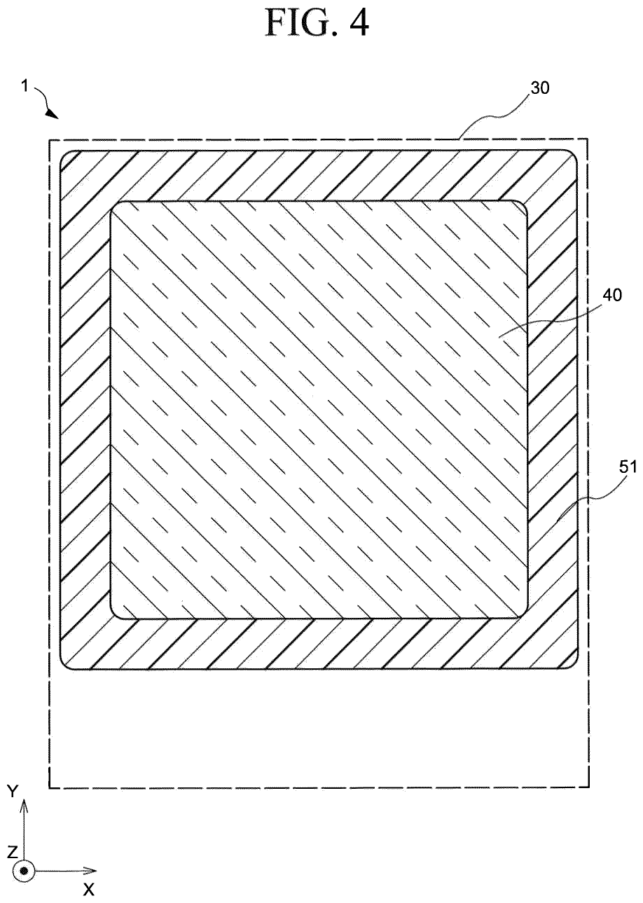

FIG. 4 shows a cross-sectional view of the line C1-C2 (see FIG. 2) of the intelligent reflecting surface 1. The sealing material 51 surrounds the liquid crystal layer 40 from four directions: the +X, −X, +Y, and −Y directions.

The sealing material 51 is a resin containing a magnetic powder, for example, epsilon iron oxide dispersed by a binder resin. The epsilon iron oxide is epsilon phase iron oxide (Fe₂O₃) and is a particle with a diameter of about several nanometers. The epsilon iron oxide has a property of absorbing high-frequency electromagnetic waves. The magnetic powder is not limited to the powder of the epsilon iron oxide, and may be a powder of a ferritic material, including iron oxide other than the epsilon phase iron oxide, hexagonal ferrite, strontium ferrite, or powder of a stainless material. The binder resin is, for example, an acrylic resin. The binder resin may be, for example, epoxy resin, polyester resin, polyurethane resin, phenolic resin, melamine resin, a rubber resin, or the like, in addition to acrylic resin. The sealing material 51 may contain a phosphoric acid compound, such as an aryl sulfonic acid, such as phenylphosphonic acid and phenylphosphonic acid dichloride, an alkyl phosphonic acid, such as methylphosphonic acid, ethylphosphonic acid, octylphosphonic acid and propylphosphonic acid, or a polyfunctional phosphonic acid, such as hydroxyethanediphosphonic acid and nitrotrismethylenephosphonic acid. Further, the resin of the sealing material 51 may include an ultraviolet curable resin and a spacer (for example, resin beads or silica beads). For example, the thickness of the sealing material 51, that is, the width in the direction Z, is several tens of μm to several hundreds of μm. The sealing material 51 may be a stacked structure. The structure including the sealing material 51 is an example of a seal portion.

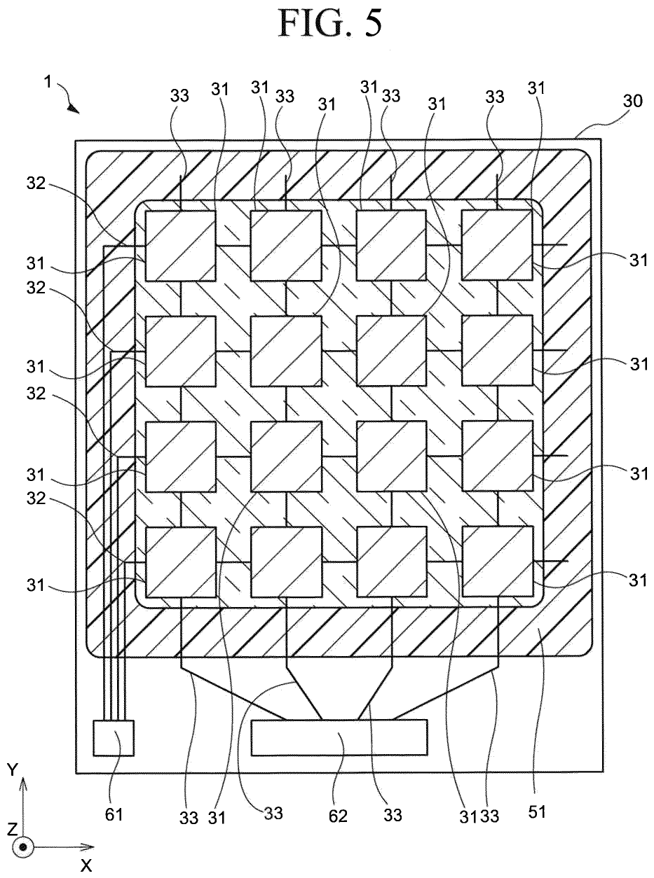

FIG. 5 shows a cross-sectional view of the line D1-D2 (see FIG. 2). Sixteen ground electrodes 31 are arranged in the direction X and the direction Y to form a group, and are arranged in a lattice pattern of 4 rows and 4 columns. Each ground electrode 31 is formed in a square shape. The length of one side of the square corresponds to the length of one side of the square of the patch electrode 21 (see FIG. 3), and is 35 mm when the frequency of the incident wave IW (see FIG. 1) is 2.4 G Hz, 16.8 mm when 5.0 GHZ, and 3.0 mm when 28 GHz. The length of one side of the ground electrode 31 does not necessarily have to be equal to the length of one side of the patch electrode 21, and the adjacent ground electrodes 31 may have a gap and may be arranged in a physically separated state. The bias signal line 32, which is a conductive thin wire extending in the direction X, and the selection signal line 33, which is a conductive thin wire extending in the direction Y, are connected to each ground electrode 31.

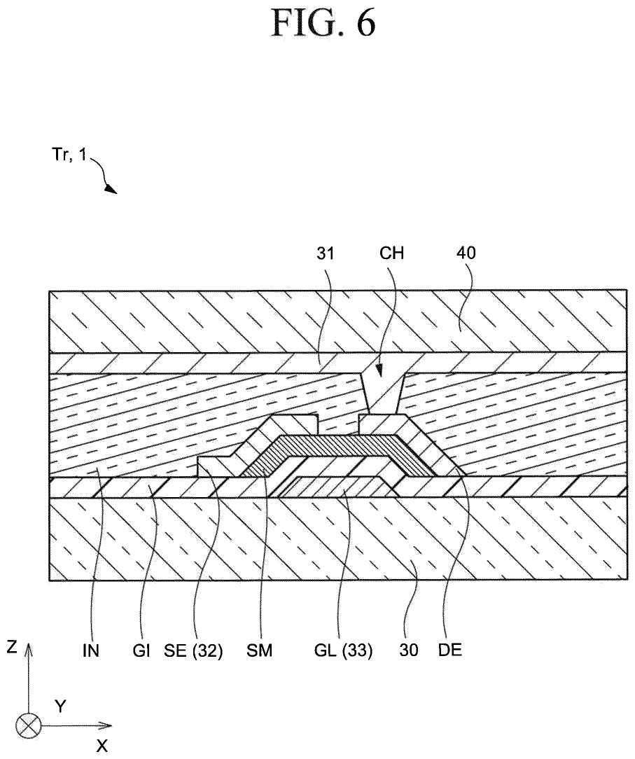

FIG. 6 shows an enlarged cross-sectional view of an SW portion of the intelligent reflecting surface 1 shown in FIG. 2. A gate electrode GL of a transistor Tr connected to the selection signal line 33 is arranged on the second substrate 30, and is covered with an insulating layer GI. A semiconductor layer SM of the transistor Tr is provided on the insulating layer GI, and a source electrode SE and a drain electrode DE are provided on a source region and a drain region of the semiconductor layer SM, respectively. The bias signal line 32 is connected to the source electrode SE. The semiconductor layer SM is covered with an insulating layer IN, and the above-described ground electrode 31 is arranged on the insulating layer IN. The ground electrode 31 is connected to the drain electrode DE via a contact hole CH formed in the insulating layer IN.

For example, the transistor Tr is a thin film transistor (TFT). When a voltage is applied to the gate electrode GL via the selection signal line 33, the transistor Tr is turned on, and the voltage supplied to the source electrode SE via the bias signal line 32 is supplied to the ground electrode 31 via the drain electrode DE.

Since the selection signal line 33 extends in the direction Y, the transistors Tr corresponding to the ground electrodes 31, arranged in one row in the direction Y, are simultaneously turned on or off. Since the bias signal line 32 extends in the direction X, the bias signal with different potentials can be supplied to the transistors Tr that are simultaneously turned on. Therefore, each ground electrode 31 is driven by an active matrix method, and the potential of each ground electrode 31 is individually controlled.

The transistor Tr may be a bottom-gate transistor or a top-gate transistor.

Returning to FIG. 2, an example of an embodiment for controlling the direction of the reflected wave RW will be described. For ease of understanding, it is assumed that the incident wave IW is incident perpendicularly to the first substrate 20 and the second substrate 30 from the side of the first substrate 20 to the side of the second substrate 30, that is, in the direction −Z. The incident wave IW incident on the position of a patch electrode 21a shown in FIG. 2 is referred to as an incident wave IW1, and the incident wave IW incident on the position of a patch electrode 21b adjacent to the patch electrode 21a is referred to as an incident wave IW2. Among the incident waves IW1 and IW2, those not reflected by the patch electrode 21a and the patch electrode 21b travel through the liquid crystal layer 40 in the −Z direction.

The potentials of the patch electrodes 21a and 21b are the same, while the potentials of ground electrodes 31a and 31b facing each other are set differently. Since the propagation speed of an electromagnetic wave in a medium varies depending on the dielectric constant, and the dielectric constant of the liquid crystal is proportional to the potential difference, the propagation speed differs between an incident wave IW2-1 and an incident wave IW2-2 traveling through the liquid crystal layer 40. The incident waves IW2-1 and IW2-2 are reflected by the ground electrodes 31a and 31b, and reflected waves RW1-1 and RW1-2 travel through the liquid crystal layer 40 in the +Z direction, respectively. Similar to the incident wave IW2-1 and the incident wave IW2-2, the propagation speed differs between the reflected wave RW1-1 and the reflected wave RW1-2 traveling through the liquid crystal layer 40. Therefore, the positions of the wavefronts of the reflected waves RW1-1 and RW1-2 that travel through the liquid crystal layer 40 and return to the patch electrodes 21a and 21b and have the same phase differ due to the difference in the propagation speed. In this case, it is assumed that the reflected wave RW1-1 is advanced compared with the reflected wave RW1-2.

The combined wave of the reflected wave reflected by the patch electrode 21a and the reflected wave reflected by the ground electrode 31a is designated as RW2-1, and the combined wave of the reflected wave reflected by the patch electrode 21b and the reflected wave reflected by the ground electrode 31b is designated as RW2-2. The reflected wave RW2-1 that exits the intelligent reflecting surface 1 is advanced compared with the reflected wave RW2-2. Therefore, a combined wavefront WF obtained by combining the wavefront of the reflected wave RW2-1 and the wavefront of the reflected wave RW2-2 is inclined with respect to the first substrate 20 and the second substrate 30 (for example, the angle θ). By making the voltage applied between the adjacent ground electrodes 31 different, the propagation speed of the radio wave traveling through the liquid crystal layer 40 can be changed, and the direction of the reflected wave RW can be inclined in a desired direction with respect to the direction X.

Since the patch electrode 21 and the ground electrode 31 are arranged in a lattice pattern in the direction X and the direction Y, the direction of the reflected wave RW can be inclined in a desired direction with respect to the direction Y by making the voltages applied between the ground electrodes 31 adjacent in the direction Y different from each other.

In the intelligent reflecting surface 1 according to the present embodiment, the patch electrode 21 is electrically connected by the common wiring 22 (see FIG. 3). Unlike the present embodiment, the potentials of the plurality of patch electrodes 21 may be individually controlled to make the potentials of the plurality of ground electrodes 31 constant.

In order to reduce any influence on the incident wave IW and the reflected wave RW, the bias signal line 32 and the selection signal line 33 (see FIG. 5) are arranged on the surface of the two surfaces of the second substrate 30 that is in contact with the liquid crystal layer 40 of the peripheral region EA. The sealing material 51 covers the bias signal line 32 and the selection signal line 33 arranged in the peripheral region EA.

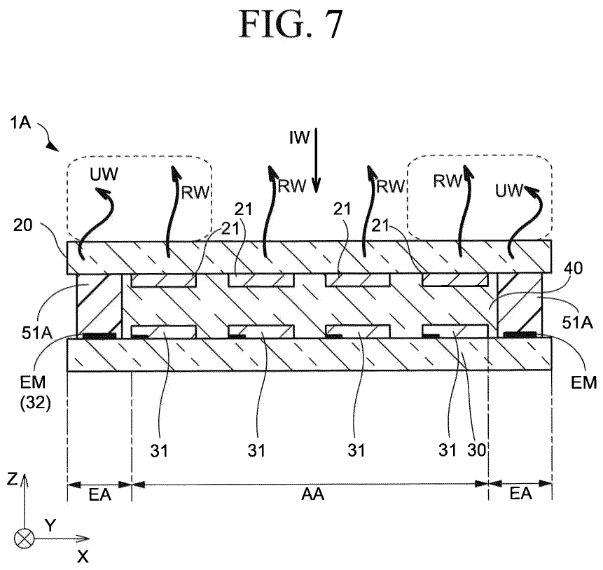

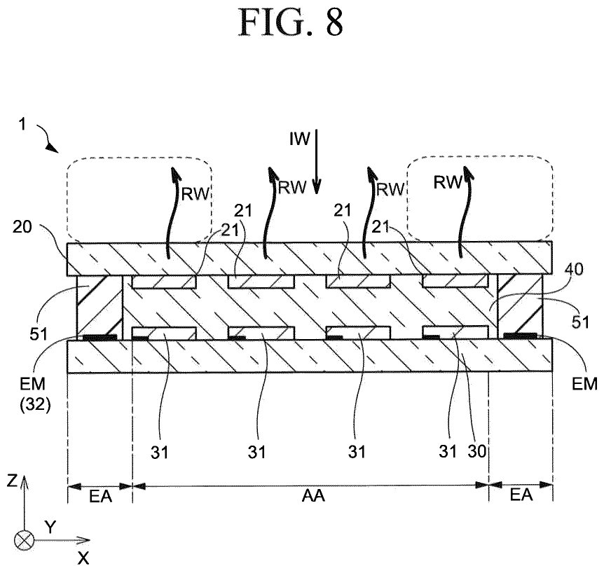

FIG. 7 and FIG. 8 are cross-sectional views of an intelligent reflecting surface 1A according to a comparative example in which the sealing material 51 does not contain the magnetic powder and the intelligent reflecting surface 1 according to the present embodiment, respectively.

In FIG. 7 and FIG. 8, a wiring EM including the bias signal line 32 is pulled out from the active region AA and arranged in the peripheral region EA. Since the wiring EM is conductive, the peripheral region EA tends to reflect the incident wave IW. However, the peripheral region EA does not have the liquid crystal layer 40 and does not have a function of adjusting the phase of the reflected wave RW. Therefore, a reflected wave UW generated in the peripheral region EA of the intelligent reflecting surface 1A according to the comparative example shown in FIG. 7 is an unintended reflected wave, and tends to have an effect such as attenuating the reflected wave RW in the active region AA, disturbing the phase of the reflected wave RW, or interfering with the reflected wave RW.

On the other hand, the incident wave IW incident on the peripheral region EA of the intelligent reflecting surface 1 according to the present embodiment shown in FIG. 8 is absorbed by the sealing material 51 covering the wiring EM, and an unintended reflected wave is less likely to be generated. For this reason, the unintended reflected wave is less likely to have effects, such as attenuating the phase-adjusted reflected wave RW, disturbing the phase of the reflected wave RW, or interfering with the reflected wave RW.

In addition, the sealing material 51 may be a resin containing a conductive material in place of or together with the magnetic powder. For example, the sealing material 51 may be a resin containing metal, boron carbide, conductive carbon powder, or silicon carbide. More specifically, the sealing material 51 may be a thermosetting resin containing boron solid-solution carbon black. Since the sealing material 51 is a conductive material, the energy of the electric wave incident on the peripheral region EA is converted into heat by loss, dielectric loss, or magnetic loss due to the electric resistance of the sealing material 51, and is absorbed by the sealing material 51. Therefore, in the case where the sealing material 51 contains a conductive material, the influence of the reflected wave can be reduced, similar to the case of using a resin containing the magnetic powder as the sealing material 51.

### Second Embodiment

In an intelligent reflecting surface 2 according to another embodiment of the present invention, a notch is provided in a part of the sealing material surrounding the liquid crystal layer 40. Hereinafter, differences from the intelligent reflecting surface 1 according to the first embodiment will be mainly described.

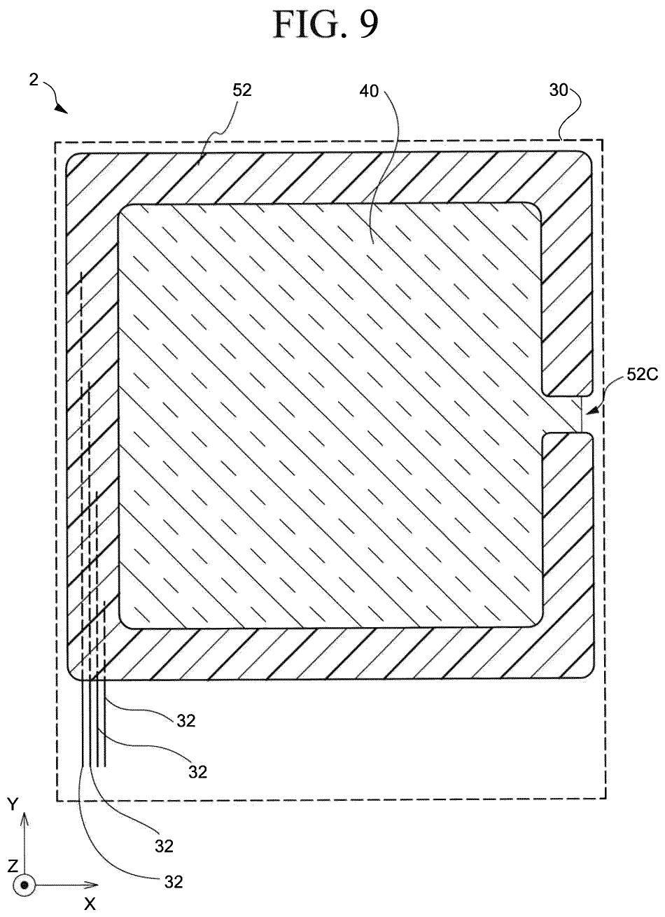

FIG. 9 is an arrow view of the intelligent reflecting surface 2 cut in a plane parallel to the same XY plane as FIG. 4. In the vicinity of the center of the right end of the second substrate 30, a sealing material 52 is provided with a notch 52C. The notch 52C is formed to have a size such that the liquid crystal of the liquid crystal layer 40 does not leak out, for example, a size of 5 mm to 10 mm.

The bias signal line 32 connected to the transistor Tr (see FIG. 5) of the ground electrode 31 is arranged on the left side (−X direction) of the second substrate 30. On the other hand, the wiring is not arranged on the right side (+X direction) of the second substrate 30. Therefore, the density of the wiring on the right side of the second substrate 30 is lower than the density of the wiring on the left side of the second substrate 30. The notch 52C functions as an injection port of the liquid crystal forming the liquid crystal layer 40 in the process of manufacturing the intelligent reflecting surface 2. Since the notch 52C is provided in a portion where the density of wiring, such as the bias signal line 32, is low, the intelligent reflecting surface 2 can reduce the effect of electromagnetic wave noise generated from the wiring on the reflected wave RW (see FIG. 1) even if there is a portion where the sealing material 52 is not provided.

The shape, size, number, and the like of the notch 52C are not limited to those described above, and may be changed in various ways as long as the liquid crystal contained in the liquid crystal layer 40 to be sealed does not leak out.

### Third Embodiment

The sealing material of an intelligent reflecting surface 3 according to another embodiment of the present invention extends beyond the space between the first substrate 20 and the second substrate 30. Hereinafter, differences from the intelligent reflecting surface 1 according to the first embodiment will be mainly described.

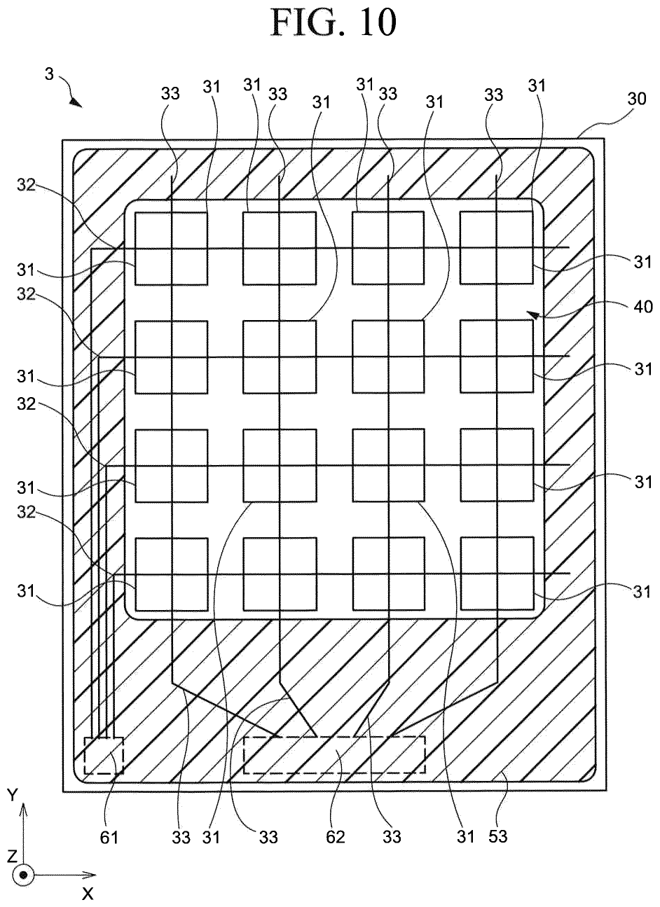

As shown in the overview of a plan view in FIG. 10, the intelligent reflecting surface 3 includes the first substrate 20, the second substrate 30, and the liquid crystal layer 40. A sealing material 53 of the present embodiment covers the periphery of the liquid crystal layer 40 and covers the connector 61 and the circuit element 62 arranged on the second substrate 30 and electrically connected to the patch electrode 21 (see FIG. 3) or the ground electrode 31.

The wiring, the connector 61, and the circuit element 62 are fixed to the second substrate 30 by the sealing material 53 that covers them. Therefore, according to the intelligent reflecting surface 3, the wiring, the connector 61, and the circuit element 62 are less likely to peel off or fall off from the second substrate 30.

In order to avoid short-circuiting of the bias signal line 32, the selection signal line 33, the electrodes of the connector 61, and the circuit element 62, it is desirable that the sealing material 53 of the present embodiment does not contain a conductive material. In the case where the sealing material 53 contains a conductive material, it is desirable to coat the surfaces of the bias signal line 32, the selection signal line 33, the electrodes of the connector 61, and the circuit element 62 with insulating paint.

The circuit element 62 on the second substrate 30 generates electromagnetic waves that are noise. According to the intelligent reflecting surface 3, the bias signal line 32, the selection signal line 33, the connector 61, and the circuit element 62 on the second substrate 30, which are sources of noise, are covered with the sealing material 52, which is a resin containing the magnetic powder. Therefore, according to the intelligent reflecting surface 3, the phase of the reflected wave RW (see FIG. 1) is less likely to be disturbed.

The sealing material 53 may contain a material having functions such as moisture resistance, water resistance, light resistance, and dust resistance.

### [Modification]

An intelligent reflecting surface 4 according to a modification is provided with a bank 52B that stabilizes the shape of the sealing material. Hereinafter, differences from the intelligent reflecting surface 1 according to the first embodiment will be mainly described.

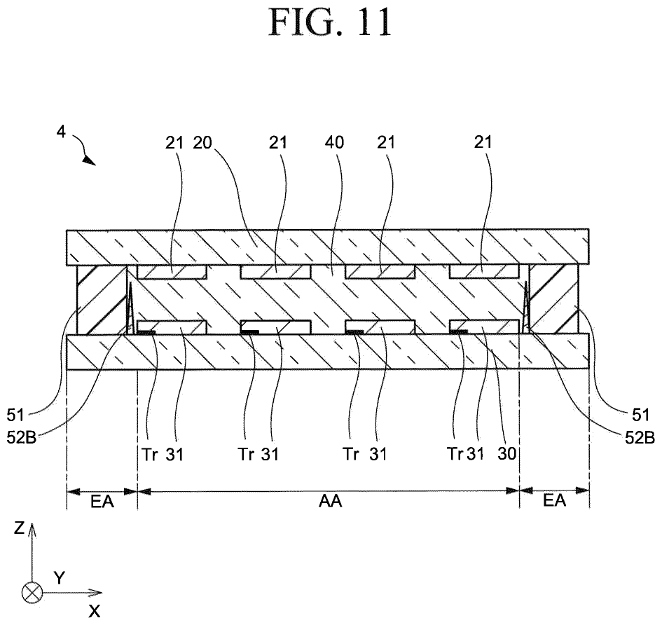

As shown in a cross-sectional view in FIG. 11, the bank 52B is provided in the peripheral region EA, preferably near the boundary between the peripheral region EA and the active region AA. The bank 52B has a surface extending perpendicularly to the second substrate 30 and is formed in a wall-like shape surrounding the liquid crystal layer 40.

When the sealing material 51 is filled, the sealing material 51 is in contact with the outer surface of the bank 52B and is restricted from entering the active region AA by the bank 52B. Therefore, according to the intelligent reflecting surface 4, the sealing material 51 can be filled up to a position close to the boundary between the peripheral region EA and the active region AA as compared with the case where there is no bank 52B. Since the bank 52B only needs to prevent the sealing material 51 from entering the active region AA, a part of the bank 52B may be arranged in the active region AA.

Although the embodiment has been described using the intelligent reflecting surface as an example, the scope of application of the present invention is not limited to the intelligent reflecting surface.

While preferred embodiments have been described above, the present invention is not limited to such embodiments. The contents disclosed in the embodiments are merely examples, and various changes can be made without departing from the spirit of the present invention. Appropriate changes that have been made without departing from the spirit of the present invention naturally fall within the technical scope of the present invention. In addition, each of the above-described embodiments can be appropriately combined as long as no contradiction is caused. Further, it is understood that, even if the effect is different from those provided by each of the above-described embodiments, the effect obvious from the description in the specification or easily predicted by persons ordinarily skilled in the art is apparently derived from the present invention.

What is claimed is:

1. An intelligent reflecting surface comprising:
a first substrate including a plurality of first electrodes arranged on the first substrate;
a second substrate including a plurality of second electrodes arranged on the second substrate, the second substrate is located opposite to the first substrate, each of the second electrodes faces each of the first electrodes, and a liquid crystal layer is arranged between the first substrate and the second substrate; and
a seal portion arranged between the first substrate and the second substrate, and enclosing the liquid crystal layer between the first substrate and the second substrate; wherein
the seal portion contains a material suppressing reflection of radio waves.

2. The intelligent reflecting surface according to claim 1, wherein the seal portion contains a magnetic powder.

3. The intelligent reflecting surface according to claim 1, wherein the seal portion contains a conductive material.

4. The intelligent reflecting surface according to claim 1, wherein the seal portion covers wirings electrically connected to the first electrode or the second electrode.

5. The intelligent reflecting surface according to claim 4, wherein the wirings are covered with an insulating material.

6. The intelligent reflecting surface according to claim 4, wherein
the wiring is pulled out to a part of a plurality of peripheral regions not including a group of the first electrodes or the second electrodes, and
the seal portion has a notch located in a region of the plurality of the peripheral regions, the region not having the greatest density of the wirings.

7. The intelligent reflecting surface according to claim 1, wherein the seal portion is located on the first substrate or the second substrate and covers a circuit element electrically connected to the first electrode or the second electrode.

8. The intelligent reflecting surface according to claim 7, wherein the circuit element is covered with an insulating material.

9. The intelligent reflecting surface according to claim 1, further comprising a bank formed from the first substrate to the second substrate or the second substrate to the first substrate and located in a peripheral region not including a group of the first electrodes or the second electrodes, wherein at least a part of the seal portion is in contact with the bank.

10. The intelligent reflecting surface according to claim 1, wherein the seal portion contains a layered structure of different sealing materials.
